(19) United States
(12) Patent Application Publication
(10) Pub. No.: US 2026/0320639 A1
(43) Pub. Date: Oct. 15, 2026

(54) SYSTEM AND METHOD FOR REAL ESTATE VALUATION AND SALES FORECASTING USING HEXAGONAL SPATIAL INDEXING AND SELF-SUPERVISED PREDICTIVE MODELING

(71) Applicant: One Brother Investments LLC - Tezintel Series, Austin, TX (US)

(72) Inventor: Naveed Ali, League City, TX (US)

(21) Appl. No.: 19/693,262

(22) Filed: May 29, 2026

Related U.S. Application Data
(63) Continuation-in-part of application No. 18/898,387, filed on Sep. 26, 2024, now abandoned.

(51) Int. Cl. G06Q 30/0201; G06Q 50/16

(52) U.S. Cl. CPC G06Q 30/0206; G06Q 50/16

(57) ABSTRACT

A computer-implemented method, system, and non-transitory computer-readable medium for site suitability evaluation subdivide a geographic region surrounding a subject location into a plurality of hexagonal cells of a hexagonal grid, each hexagonal cell being adjacent to six neighboring hexagonal cells. A feature value derived from geospatial data is assigned to each hexagonal cell. A distance-weighted influence value is computed for each hexagonal cell using a kernel function across a neighbor ring. A target label is generated for each hexagonal cell of a training subset by aggregating feature values across the neighbor ring without manual labeling. A predictive model is trained on the feature values and target labels to output a suitability weight vector. A composite suitability score is computed as a weighted sum of normalized criterion values using weights derived from the suitability weight vector, and is output for the subject location.

### CROSS-REFERENCE TO RELATED APPLICATION

This application is a continuation-in-part of U.S. patent application Ser. No. 18/898,387, filed Sep. 26, 2024, the entirety of which is incorporated herein by reference.

### COPYRIGHT AND TRADE DRESS NOTICE

A portion of the disclosure of this patent document contains material that is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

### 1. Field of the Invention

The present invention relates generally to computer-implemented systems for real estate valuation and sales forecasting, and more specifically, to a system and method for evaluating candidate real estate sites and forecasting commercial sales potential at those sites using hexagonal spatial indexing of geospatial data and self-supervised training of a predictive model on labels derived from spatial neighborhoods.

### 2. Description of Related Art

This background information is intended to further educate the reader as to additional aspects of the prior art and may present examples of specific aspects of the prior art that is not to be construed as limiting the disclosure of the present application.

Computer-implemented systems for real estate valuation and sales forecasting have conventionally relied on the manual assembly of comparable-property data sets, the manual evaluation of demographic and competitive indicators surrounding a candidate site, and the separate computation of sales projections from operational parameters supplied by a user. A real estate investor, operator, or developer evaluating a candidate site under such a conventional system typically obtains a property valuation from a first software tool, obtains a demographic profile of the surrounding area from a second software tool, and projects commercial sales potential at the candidate site from a third software tool, with no integrated workflow that propagates a change in any one of these inputs through to the others.

Conventional real estate valuation and sales forecasting systems further suffer from a manual-data-entry bottleneck. For each candidate site, a user manually identifies the geographic boundary of the market surrounding the candidate site, manually obtains demographic and competitive information for that geographic boundary, and manually enters that information into the valuation tool. The manual identification of the surrounding market is subjective and inconsistent between users, and the manual data entry is impractical at the scale necessary to evaluate a portfolio of candidate sites.

Once the foregoing manual steps have been performed, conventional real estate valuation and sales forecasting systems produce a single static report for the candidate site. A user wishing to consider an alternative operational configuration at the candidate site, such as an alternative service category, an alternative physical footprint, an alternative staffing count, or an alternative pricing assumption, rebuilds the report from the beginning by re-entering the manually-curated data with the modified operational parameters. The conventional architecture does not permit interactive evaluation of alternative operational configurations at the candidate site.

Conventional real estate valuation and sales forecasting systems further lack an integrated mechanism for coordinating additional services that a user may wish to procure in association with a candidate site, such as a property inspection, a property appraisal, an environmental assessment, or a construction-cost estimate. A user wishing to procure such additional services typically engages separate service providers through separate workflows external to the valuation tool, with no integrated path from the candidate-site evaluation through to the procurement and delivery of the additional services.

In addition to the foregoing deficiencies that relate to the workflow of conventional real estate valuation and sales forecasting systems, conventional systems also suffer from technical limitations that arise from the way the underlying computer represents and operates on geospatial data, rather than from the human activity of evaluating a candidate site. These technical limitations are described below.

Computer-implemented systems that evaluate the suitability of a geographic site for a particular use have conventionally relied on rectangular grid representations of geographic regions, manually-curated training data sets for any predictive modeling step, and isolated point-in-polygon queries against fragmented geospatial data sources. These conventional architectures suffer from several technical limitations that arise from the way a computer represents and operates on spatial data, rather than from the human activity of evaluating a site.

A first technical limitation is that rectangular grid representations of geographic regions introduce distortion when computing neighborhood relationships, because cells along a row and cells along a column are separated by different center-to-center distances than cells along a diagonal. A computer operating on a rectangular grid must therefore apply a separate distance correction whenever it aggregates feature values across neighboring cells, and the correction depends on the geographic latitude of the region under analysis. This distortion compounds when feature values are aggregated across multiple resolutions of the same region, because parent cells and child cells of a rectangular grid do not nest cleanly without overlap or remainder.

A second technical limitation is that conventional predictive models for spatial analysis require manually-labeled training data. For each geographic location in a training data set, a human annotator must record a ground-truth outcome value, typically by examining historical records or by performing a separate analysis. This manual labeling step creates a bottleneck that limits the size of the training data set, introduces inconsistency between annotators, and is impractical for geographic regions that have not previously been analyzed.

A third technical limitation is that conventional systems generate separate outputs for spatial analysis, predictive modeling, and financial computation, with each output requiring its own pipeline. A change to an operational parameter of a site, such as a change in service hours or in physical configuration, propagates through the financial computation only if the spatial and predictive outputs are recomputed independently. The lack of a unified pipeline that propagates operational configuration through to financial outputs has prevented existing systems from supporting interactive scenario analysis at scale.

A fourth technical limitation is that conventional systems lack an integrated mechanism for refining predictive model parameters in response to observed outcomes after a site has been evaluated. Once a prediction has been made, the predictive model is not updated based on the actual outcome that subsequently occurs at the site, so the model accuracy does not improve over time without manual retraining.

Accordingly, there exists a need for a computer-implemented system and method for real estate valuation and sales forecasting that addresses the foregoing workflow deficiencies through an integrated user interface, processing, and service management architecture, and that further addresses the foregoing technical limitations of conventional spatial data processing through a uniform spatial discretization, a self-supervised training procedure that does not require manually-labeled training data, a unified computational pipeline that propagates an operational configuration of a candidate site into a real estate valuation and a sales forecast, and an integrated feedback mechanism that refines the predictive model in response to observed outcomes at evaluated sites.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In one aspect, the present disclosure provides a system for real estate valuation and sales forecasting comprising a user interface module through which a user submits a candidate site location and an operational configuration associated with the candidate site location, a processing module that generates a real estate valuation and a sales forecast for the candidate site based on the candidate site location, the operational configuration, and a body of geospatial data, and a service management module that coordinates additional services associated with the candidate site, such as a property inspection, a property appraisal, an environmental assessment, or a construction-cost estimate, procured through the system in response to user selection.

The user interface module, the processing module, and the service management module are integrated such that a change to the operational configuration submitted through the user interface module propagates through the processing module to produce an updated real estate valuation and an updated sales forecast without restarting the workflow, and such that a user selection of additional services in the user interface module causes the service management module to coordinate the procurement and delivery of those additional services in association with the candidate site. The integrated architecture addresses the workflow deficiencies of conventional real estate valuation and sales forecasting systems described above.

In another aspect, the processing module computes the real estate valuation and the sales forecast using a hexagonal spatial indexing procedure and a predictive model trained by a self-supervised procedure. The use of hexagonal spatial indexing of geospatial data in place of a rectangular grid representation, and the use of self-supervised training of the predictive model on labels derived from spatial neighborhoods in place of manually-labeled training data, together address the technical limitations of conventional spatial data processing described above. The hexagonal spatial indexing procedure and the self-supervised training procedure are described in further detail in the following paragraphs.

The disclosure of the present application addresses the above stated deficiencies with conventional computer-implemented spatial data processing. The present disclosure provides a system and method for site suitability evaluation in which a geographic region is subdivided into a plurality of hexagonal cells of a hexagonal grid, each hexagonal cell having a defined cell-center coordinate and being adjacent to six neighboring hexagonal cells of the hexagonal grid. The uniform six-neighbor adjacency of the hexagonal grid permits a computer to aggregate feature values across neighboring cells without applying a distance correction, and permits multi-resolution aggregation in which parent and child cells nest without overlap or remainder.

In one embodiment, a feature value is assigned to each hexagonal cell of the plurality, the feature value being derived from geospatial data localized to that hexagonal cell. A distance-weighted influence value is then computed for each hexagonal cell as a function of the feature values of the hexagonal cells located within a neighbor ring of that hexagonal cell and a kernel function that decreases with neighbor-ring distance. The distance-weighted influence value captures the combined effect of features surrounding a given location while preserving the spatial uniformity of the hexagonal grid.

In another aspect, a target label is generated for each hexagonal cell of a training subset of the plurality by aggregating the feature values of the hexagonal cells located within the neighbor ring of that hexagonal cell, the target label being generated without manual labeling. A predictive model is then trained using the feature values and the target labels of the training subset to output, in response to a feature vector of a given hexagonal cell, a suitability weight vector for the given hexagonal cell. The self-supervised generation of target labels removes the manual-labeling bottleneck described in the background and permits the predictive model to be trained on any geographic region for which geospatial data is available.

In another aspect, the trained predictive model is applied to a feature vector of a subject hexagonal cell containing a subject location to produce a suitability weight vector for the subject hexagonal cell. A composite suitability score is then computed for the subject location as a weighted sum of a plurality of normalized criterion values associated with the subject hexagonal cell, where each weight of the weighted sum is derived from the suitability weight vector for the subject hexagonal cell. The composite suitability score is output for further processing or display.

In another aspect, an observed outcome associated with the subject location is received after the composite suitability score is output. The observed outcome is compared with a predicted outcome derived from the composite suitability score, and at least one parameter of the predictive model is updated based on the comparison. This feedback procedure permits the predictive model to refine its parameters over time in response to outcomes that actually occur at evaluated sites.

In another aspect, a plurality of operational configuration parameters associated with the subject location is received. A financial projection for the subject location is computed as a function of the plurality of operational configuration parameters and the composite suitability score. The financial projection is propagated through the same computational pipeline as the composite suitability score, so a change to an operational configuration parameter produces an updated financial projection without requiring the predictive model to be retrained.

### BRIEF DESCRIPTION OF THE DRAWINGS

The accompanying drawings, which are incorporated in and constitute a part of this disclosure, illustrate exemplary aspects and, together with the description, serve to explain the disclosed principles. Some aspects of system and/or methods in accordance with aspects of the present subject matter are now described, by way of example only, and with reference to the accompanying Figures, in which:

FIG. 1 is a block diagram of a system for site suitability evaluation, in accordance with a preferred embodiment of the present application;

FIG. 2 is a schematic representation of a hexagonal grid showing a hexagonal cell, six neighboring hexagonal cells adjacent to the hexagonal cell, and a neighbor ring of the hexagonal cell at integer ring distances of one, two, and three, in accordance with a preferred embodiment of the present application;

FIG. 3 is a schematic representation of a hierarchical hexagonal grid showing a parent hexagonal cell at a coarser resolution and a plurality of child hexagonal cells at a finer resolution of the hexagonal grid, in accordance with a preferred embodiment of the present application;

FIG. 4 is a schematic representation of a kernel function applied across a neighbor ring of a hexagonal cell to compute a distance-weighted influence value, in accordance with a preferred embodiment of the present application;

FIG. 5 is a flow diagram of a self-supervised label generation process in which a target label for each hexagonal cell of a training subset is computed by aggregating feature values of hexagonal cells located within the neighbor ring of that hexagonal cell, in accordance with a preferred embodiment of the present application;

FIG. 6 is a flow diagram of a predictive model training and application process in which a predictive model is trained on the feature values and the target labels of the training subset and is then applied to a feature vector of a subject hexagonal cell, in accordance with a preferred embodiment of the present application;

FIG. 7 is a flow diagram of a composite suitability score computation in which a weighted sum of normalized criterion values is computed using weights derived from a suitability weight vector, in accordance with a preferred embodiment of the present application; and

FIG. 8 is a flow diagram of an adaptive recalibration process in which at least one parameter of the predictive model is updated based on a comparison of an observed outcome with a predicted outcome, in accordance with a preferred embodiment of the present application.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the present disclosure, reference will now be made to the embodiment illustrated in the drawings, and specific language will be used to describe the same. It will nevertheless be understood that no limitation of the scope of the disclosure is thereby intended. Such alterations and further modifications in the illustrated system, and such further applications of the principles of the disclosure as illustrated therein would be contemplated as would normally occur to one skilled in the art to which the disclosure relates. Unless otherwise defined, all technical and scientific terms used herein have the same meaning as commonly understood by one of ordinary skilled in the art. The system, methods, and examples provided herein are illustrative only and are not intended to be limiting.

In one embodiment, the system and method disclosed herein operates within an operational context comprising a user registration step, an input gathering step, a report generation step, a service selection step, a service procurement step, and a report delivery step. A user accesses the system through a user device and registers a user account with the system at step 102. The user submits, at step 104, a candidate site location and an operational configuration associated with the candidate site location. The system generates, at step 106, a real estate valuation report and a sales forecast report for the candidate site location based on the candidate site location, the operational configuration, and a body of geospatial data accessible to the system.

The user reviews, at step 108, the real estate valuation report and the sales forecast report and optionally selects, at step 110, one or more additional services to be procured in association with the candidate site location. The additional services comprise, in one embodiment, a property inspection, a property appraisal, an environmental assessment, a construction-cost estimate, a title-search service, a financing-prequalification service, or any combination thereof. The system procures, at step 112, the additional services selected by the user from one or more service providers communicatively coupled to the system. The system delivers, at step 114, the real estate valuation report, the sales forecast report, and a result of the additional services to the user device. The user receives, at step 116, the delivered reports and results through the user device.

The system implementing the operational context described above comprises a user interface module 200, a processing module 208, and a service management module 210. The user interface module 200 provides a user-facing interface 202 through which the user submits the candidate site location, the operational configuration, and the selection of additional services. The user interface module 200 further comprises a registration sub-component 204 that registers the user account with the system, a submission sub-component 206 that receives the candidate site location and the operational configuration from the user, and a delivery sub-component 212 that delivers the reports and results to the user device.

The processing module 208 generates the real estate valuation report and the sales forecast report based on the candidate site location, the operational configuration, and the geospatial data accessible to the system. The processing module 208 further comprises a geospatial data ingestion sub-component 302 that retrieves geospatial data from one or more geospatial data sources, a valuation sub-component 304 that computes a real estate valuation for the candidate site based on the geospatial data and the operational configuration, a sales forecast sub-component 306 that computes a sales forecast for the candidate site based on the geospatial data and the operational configuration, a report assembly sub-component 308 that assembles the real estate valuation report and the sales forecast report, and a service coordination sub-component 310 that communicates with the service management module 210 to coordinate the procurement of additional services.

The service management module 210 coordinates the procurement of additional services from the one or more service providers communicatively coupled to the system and the delivery of results of the additional services to the user device. The service management module 210 receives a service selection from the user interface module 200, transmits a service request to the one or more service providers, receives a service result from the one or more service providers, and forwards the service result to the delivery sub-component 212 of the user interface module 200 for delivery to the user device.

In one embodiment, the user-facing interface 202 of the user interface module 200 comprises a graphical user interface rendered on a display of the user device, the graphical user interface comprising a candidate-site-selection control 402 through which the user submits the candidate site location, an operational-configuration control 502 through which the user submits the operational configuration, a report-display control 504 through which the user reviews the real estate valuation report and the sales forecast report, an additional-services-selection control 506 through which the user selects the additional services to be procured, and a service-result-display control 510 through which the user reviews the result of the additional services.

In an improved embodiment further described herein, the processing module 208 computes the real estate valuation and the sales forecast using a hexagonal spatial indexing procedure and a predictive model trained by a self-supervised procedure. The hexagonal spatial indexing procedure subdivides a geographic region surrounding the candidate site location into a plurality of hexagonal cells of a hexagonal grid, assigns a feature value derived from the geospatial data to each hexagonal cell of the plurality, and computes a distance-weighted influence value for each hexagonal cell of the plurality using a kernel function applied across a neighbor ring of the hexagonal cell. The predictive model is trained on target labels generated by the self-supervised procedure and outputs, in response to a feature vector of a given hexagonal cell, a suitability weight vector that is used to compute a composite suitability score from a plurality of normalized criterion values. The real estate valuation and the sales forecast are derived from the composite suitability score in combination with the operational configuration. The remainder of the detailed description describes a hardware system that performs the hexagonal spatial indexing procedure, the self-supervised training procedure, the composite suitability score computation, an adaptive recalibration of the predictive model in response to observed outcomes at evaluated sites, and a configuration-driven financial projection that derives the real estate valuation and the sales forecast from the composite suitability score and the operational configuration.

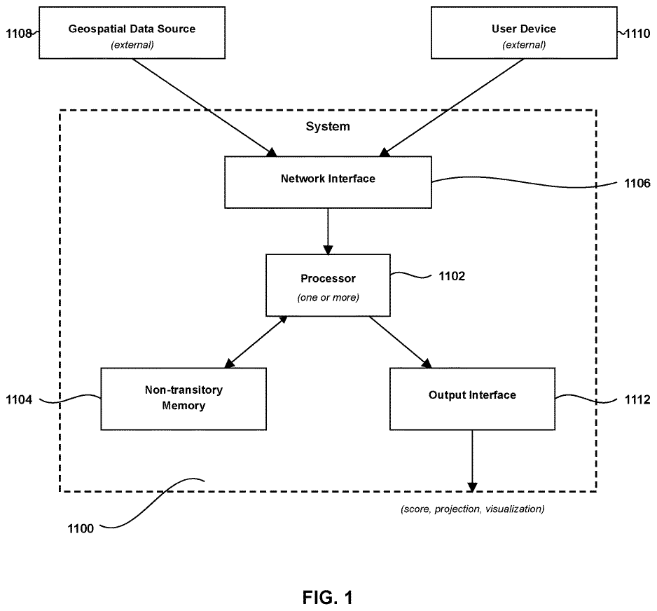

Referring now to FIG. 1, a system 1100 for site suitability evaluation comprises a processor 1102 and a non-transitory memory 1104 storing instructions that, when executed by the processor 1102, cause the processor 1102 to perform a plurality of operations described herein. The system 1100 further comprises a network interface 1106 through which the processor 1102 receives geospatial data from one or more geospatial data sources 1108 and receives location data identifying a subject location from a user device 1110. The system 1100 further comprises an output interface 1112 through which the processor 1102 outputs a composite suitability score, a financial projection, a visualization representation of a geographic region, or any combination thereof.

In one embodiment, the processor 1102 comprises one or more general-purpose central processing units. In another embodiment, the processor 1102 comprises one or more graphics processing units, one or more tensor processing units, or any combination thereof, configured to execute the instructions stored in the non-transitory memory 1104. In yet another embodiment, the processor 1102 comprises a plurality of processing cores distributed across a plurality of physical computing devices, and the non-transitory memory 1104 comprises a corresponding plurality of memory devices, the plurality of physical computing devices being communicatively coupled to one another through the network interface 1106.

The geospatial data source 1108 comprises any source of data associated with a geographic coordinate or with a geographic region. In one embodiment, the geospatial data source 1108 comprises a public mapping service, a private mapping service, a parcel records database, a traffic data feed, a demographic data feed, a point-of-interest database, an aerial imagery archive, a satellite imagery archive, or any combination thereof. The geospatial data source 1108 provides geospatial data to the processor 1102 through the network interface 1106 on demand, on a periodic schedule, or in response to an event detected by the processor 1102.

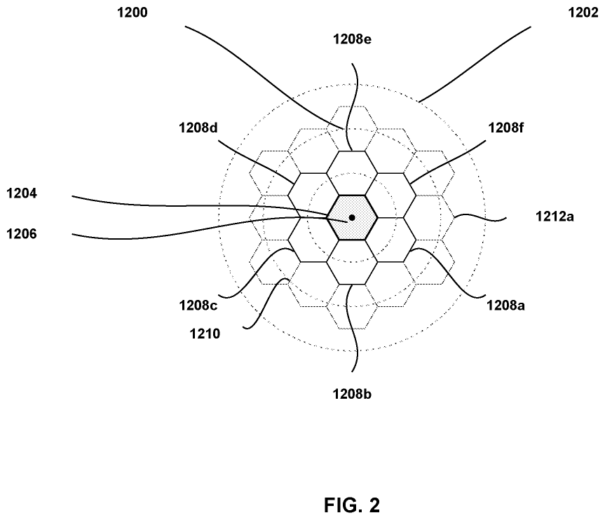

Referring now to FIG. 2, the processor 1102 subdivides a geographic region surrounding the subject location into a plurality of hexagonal cells 1200 of a hexagonal grid 1202. Each hexagonal cell 1204 of the plurality has a defined cell-center coordinate 1206 and is adjacent to six neighboring hexagonal cells 1208a, 1208b, 1208c, 1208d, 1208e, 1208f of the hexagonal grid 1202. The six-neighbor adjacency of the hexagonal grid 1202 is a structural property that follows from the geometry of regular hexagons tiling a plane, in that each interior edge of a regular hexagon abuts exactly one edge of exactly one other regular hexagon of the tiling.

In one embodiment, the cell-center coordinate 1206 of each hexagonal cell 1204 is expressed as a pair of geographic coordinates, such as a latitude and a longitude, in a defined geographic coordinate system. In another embodiment, the cell-center coordinate 1206 is expressed as a pair of planar coordinates in a map projection of the geographic region, such as a Mercator projection, a Lambert conformal conic projection, or an equal-area projection.

A neighbor ring 1210 of the hexagonal cell 1204 comprises every hexagonal cell of the hexagonal grid 1202 located within an integer ring distance of the hexagonal cell 1204. In one embodiment, the integer ring distance is one and the neighbor ring 1210 comprises the six neighboring hexagonal cells 1208a, 1208b, 1208c, 1208d, 1208e, 1208f. In another embodiment, the integer ring distance is two and the neighbor ring 1210 comprises the six neighboring hexagonal cells 1208a, 1208b, 1208c, 1208d, 1208e, 1208f together with the twelve hexagonal cells 1212a, 1212b, 1212c, 1212d, 1212e, 1212f, 1212g, 1212h, 1212i, 1212j, 1212k, 12121 that are each adjacent to at least one of the six neighboring hexagonal cells but are not the hexagonal cell 1204 itself. In yet another embodiment, the integer ring distance is three or greater, and the neighbor ring 1210 comprises every hexagonal cell of the hexagonal grid 1202 whose cell-center coordinate is reachable from the cell-center coordinate 1206 of the hexagonal cell 1204 by traversing a chain of edge-adjacent hexagonal cells of length less than or equal to the integer ring distance.

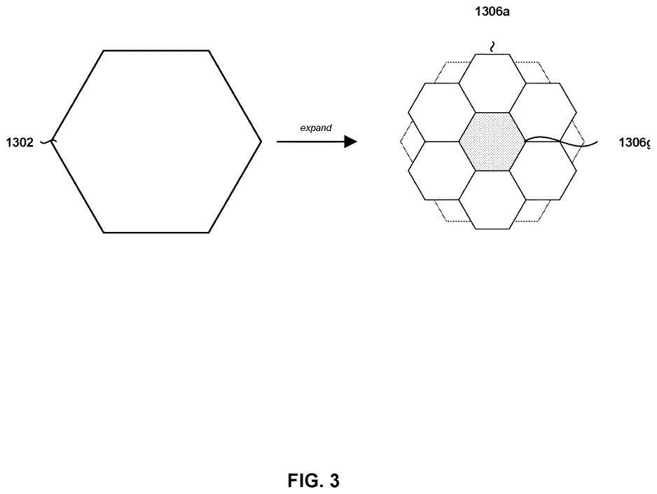

Referring now to FIG. 3, in one embodiment, the hexagonal grid 1202 is a hierarchical hexagonal grid 1300 in which each hexagonal cell 1204 of the plurality has a parent hexagonal cell 1302 at a coarser resolution 1304 of the hexagonal grid and a plurality of child hexagonal cells 1306a, 1306b, 1306c, 1306d, 1306e, 1306f, 1306g at a finer resolution 1308 of the hexagonal grid. The coarser resolution 1304 and the finer resolution 1308 are related by a fixed aperture, such that each parent hexagonal cell 1302 at the coarser resolution 1304 contains a fixed number of child hexagonal cells 1306a, 1306b, 1306c, 1306d, 1306e, 1306f, 1306g at the finer resolution 1308. In one embodiment, the fixed aperture is seven, and each parent hexagonal cell 1302 contains seven child hexagonal cells at the next finer resolution 1308.

In one embodiment, the hierarchical hexagonal grid 1300 is implemented using a hierarchical hexagonal index in which each hexagonal cell 1204 is associated with a unique index value that encodes both the resolution of the hexagonal cell 1204 and a position of the hexagonal cell 1204 within the hierarchy. The unique index value permits the processor 1102 to determine, without traversing the hierarchy, the parent hexagonal cell 1302 at any coarser resolution 1304 and the plurality of child hexagonal cells at any finer resolution 1308. One such hierarchical hexagonal index is the H3 index promulgated as an open specification, but the disclosure is not limited to that specific index, and any hierarchical hexagonal index that satisfies the foregoing properties is contemplated as falling within the scope of the disclosure.

An advantage of the hexagonal grid 1202, including the hierarchical hexagonal grid 1300, over a rectangular grid for site suitability evaluation is that the six-neighbor adjacency of the hexagonal grid 1202 is uniform across every interior hexagonal cell 1204, whereas the eight-neighbor adjacency of a rectangular grid (counting edge and corner neighbors) is non-uniform in that edge neighbors are separated by a different center-to-center distance than corner neighbors. The non-uniformity of rectangular adjacency requires a computing system that aggregates feature values across neighboring rectangular cells to apply a distance correction whose magnitude depends on the position of each neighboring rectangular cell relative to a central rectangular cell, and the distance correction further depends on the geographic latitude when the rectangular grid is projected onto a curved geographic surface. The hexagonal grid 1202 does not require such a distance correction because the six neighboring hexagonal cells 1208a, 1208b, 1208c, 1208d, 1208e, 1208f are each separated from the central hexagonal cell 1204 by the same center-to-center distance, regardless of the position of the neighboring hexagonal cells around the central hexagonal cell.

The processor 1102 assigns a feature value 1400 to each hexagonal cell 1204 of the plurality, the feature value 1400 being derived from geospatial data localized to that hexagonal cell 1204. Geospatial data is localized to a hexagonal cell 1204 when the geospatial data is associated with a geographic location whose coordinates fall within the geographic boundary of the hexagonal cell 1204.

In one embodiment, the geospatial data localized to the hexagonal cell 1204 comprises a count of points of interest of a defined category that fall within the geographic boundary of the hexagonal cell 1204. In another embodiment, the geospatial data localized to the hexagonal cell 1204 comprises a sum of a property attribute, such as a parcel area, an assessed property value, a residential population count, or a vehicle traffic count, summed across every record in the geospatial data source 1108 whose geographic location falls within the geographic boundary of the hexagonal cell 1204. In yet another embodiment, the geospatial data localized to the hexagonal cell 1204 comprises a statistical aggregation, such as a mean, a median, a percentile, a maximum, or a minimum, of a property attribute taken across every record whose geographic location falls within the geographic boundary of the hexagonal cell 1204.

In one embodiment, the feature value 1400 is a scalar value. In another embodiment, the feature value 1400 is a vector of two or more scalar values, each scalar value of the vector corresponding to a respective category of geospatial data localized to the hexagonal cell 1204. In yet another embodiment, the feature value 1400 comprises a tensor of two or more dimensions, such as a tensor representing a histogram of point-of-interest counts across a plurality of categories, or a tensor representing a time series of an aggregated property attribute over a defined time window.

In one embodiment, the processor 1102 normalizes the feature value 1400 of each hexagonal cell 1204 by dividing the feature value 1400 by a normalization factor associated with the geographic region. The normalization factor is computed as one of a maximum feature value across every hexagonal cell of the plurality, a sum of feature values across every hexagonal cell of the plurality, or a fixed reference value associated with the category of geospatial data. The normalized feature value 1400 falls within a defined numerical range, such as zero to one, regardless of the absolute magnitude of the geospatial data localized to the hexagonal cell 1204.

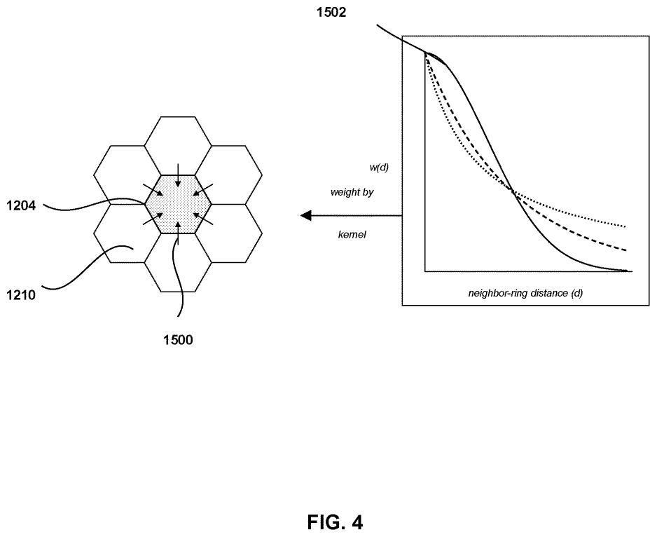

Referring now to FIG. 4, the processor 1102 computes, for each hexagonal cell 1204 of the plurality, a distance-weighted influence value 1500 as a function of (i) the feature values 1400 of the hexagonal cells located within the neighbor ring 1210 of that hexagonal cell 1204, and (ii) a kernel function 1502 that decreases with neighbor-ring distance from the hexagonal cell 1204. The distance-weighted influence value 1500 captures the combined effect of features surrounding the hexagonal cell 1204, weighted such that features in closer hexagonal cells contribute more than features in more distant hexagonal cells.

In one embodiment, the kernel function 1502 is a Gaussian function of the form w(d) equal to the exponential of negative d squared divided by twice the square of a bandwidth parameter sigma, where d is the neighbor-ring distance from the hexagonal cell 1204 and sigma is a bandwidth parameter that controls the rate at which the kernel function 1502 decreases. In another embodiment, the kernel function 1502 is an exponential decay function of the form w(d) equal to the exponential of negative lambda times d, where lambda is a decay rate parameter. In yet another embodiment, the kernel function 1502 is an inverse-distance function of the form w(d) equal to one divided by a quantity of one plus d, or more generally w(d) equal to one divided by a quantity a plus b times d to the power p, where a, b, and p are kernel parameters.

The distance-weighted influence value 1500 for the hexagonal cell 1204 is then computed as a sum, taken over every hexagonal cell c located within the neighbor ring 1210 of the hexagonal cell 1204, of the product of (i) the value of the kernel function 1502 evaluated at the neighbor-ring distance from the hexagonal cell 1204 to the hexagonal cell c, and (ii) the feature value 1400 of the hexagonal cell c.

In one embodiment, the processor 1102 computes a separate distance-weighted influence value 1500 for each of a plurality of categories of geospatial data, and combines the plurality of distance-weighted influence values into a spatial feature vector 1510 associated with the hexagonal cell 1204. The spatial feature vector 1510 captures the combined effect of multiple categories of features surrounding the hexagonal cell 1204 and is provided as an input to the predictive model described below.

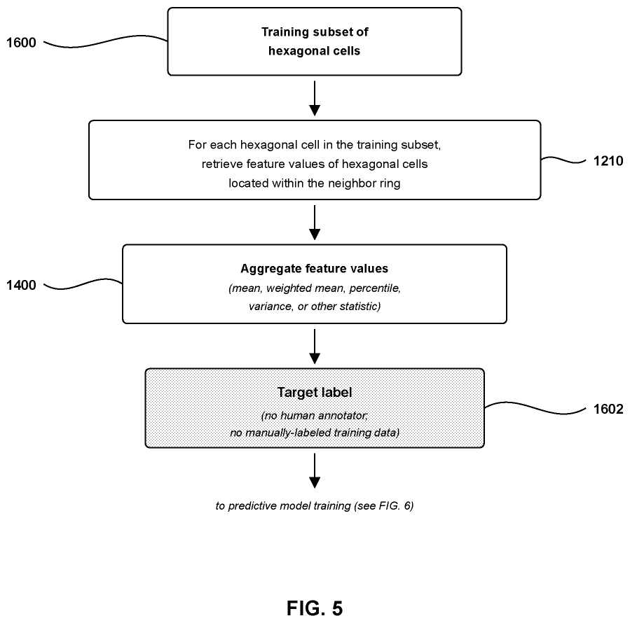

Referring now to FIG. 5, the processor 1102 generates, for each hexagonal cell 1204 of a training subset 1600 of the plurality, a target label 1602 by aggregating the feature values 1400 of the hexagonal cells located within the neighbor ring 1210 of that hexagonal cell 1204, the target label 1602 being generated without manual labeling. The training subset 1600 is selected from the plurality of hexagonal cells by the processor 1102 according to a sampling procedure described below, and the target label 1602 is computed by the processor 1102 from data already present in the geospatial data source 1108, without any human annotator recording a ground-truth value for any hexagonal cell of the training subset 1600.

In one embodiment, the target label 1602 for a hexagonal cell 1204 of the training subset 1600 is computed as a mean of the feature values 1400 of the hexagonal cells located within the neighbor ring 1210 of that hexagonal cell 1204. In another embodiment, the target label 1602 is computed as a weighted mean of the feature values 1400 within the neighbor ring 1210, the weights being derived from the kernel function 1502. In yet another embodiment, the target label 1602 is computed as a higher-order statistic, such as a variance, a skewness, a percentile, or an entropy, of the feature values 1400 within the neighbor ring 1210.

In one embodiment, the target label 1602 for a hexagonal cell 1204 of the training subset 1600 is computed from feature values of a category of geospatial data different from the category of geospatial data from which the feature value 1400 of the hexagonal cell 1204 is computed. For example, the feature value 1400 of the hexagonal cell 1204 may comprise a population count localized to the hexagonal cell 1204, while the target label 1602 of the hexagonal cell 1204 may comprise a mean of vehicle traffic counts of the hexagonal cells located within the neighbor ring 1210 of the hexagonal cell 1204. The predictive model trained on this data therefore learns to predict a vehicle traffic neighborhood characteristic from a population feature, capturing a spatial relationship between two distinct categories of geospatial data.

In one embodiment, the training subset 1600 comprises every hexagonal cell of the plurality. In another embodiment, the training subset 1600 is selected by sampling a defined number of hexagonal cells uniformly at random from the plurality. In yet another embodiment, the training subset 1600 is selected by stratified sampling, such that each of a plurality of geographic sub-regions of the geographic region is represented in the training subset 1600 by a defined number of hexagonal cells. The stratified sampling reduces the risk that the predictive model overfits to characteristics of a particular geographic sub-region that is over-represented in a uniform random sample.

The self-supervised target label generation described above removes the manual-labeling bottleneck described in the background. Because the target label 1602 is computed from geospatial data already present in the geospatial data source 1108, the predictive model can be trained on any geographic region for which geospatial data is available, without any human annotator recording a ground-truth value for any hexagonal cell. The size of the training subset 1600 is therefore limited only by the geographic extent of the geospatial data, rather than by the availability of human annotators.

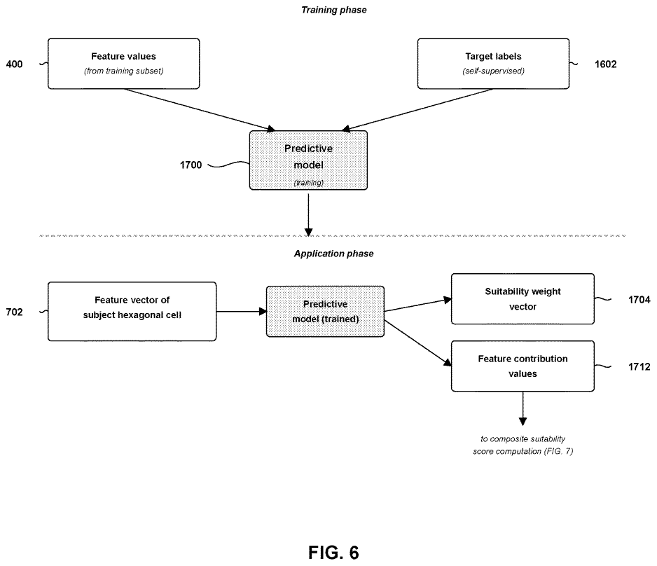

Referring now to FIG. 6, the processor 1102 trains a predictive model 1700, using the feature values 1400 and the target labels 1602 of the training subset 1600, to output, in response to a feature vector 1702 of a given hexagonal cell 1204, a suitability weight vector 1704 for the given hexagonal cell 1204. The feature vector 1702 for a hexagonal cell 1204 comprises the feature value 1400 of the hexagonal cell 1204, the distance-weighted influence value 1500 of the hexagonal cell 1204, the spatial feature vector 1510 of the hexagonal cell 1204, or any combination thereof.

In one embodiment, the predictive model 1700 comprises a gradient-boosted regression model. In one such embodiment, the gradient-boosted regression model comprises an ensemble of decision trees in which each successive decision tree is trained to predict a residual error of an ensemble of previously-trained decision trees on the feature values 1400 and the target labels 1602 of the training subset 1600. In another embodiment, the predictive model 1700 comprises a random forest regression model, a neural network regression model, a support vector regression model, a linear regression model, a Gaussian process regression model, or any combination thereof.

In one embodiment, the predictive model 1700 is trained to minimize a loss function defined over the training subset 1600, the loss function comprising a mean squared error between predicted target labels output by the predictive model 1700 and the target labels 1602 generated by the self-supervised procedure described above. In another embodiment, the loss function comprises a mean absolute error, a Huber loss, a quantile loss, or any combination thereof.

The processor 1102 applies the trained predictive model 1700 to the feature vector 1702 of a subject hexagonal cell 1710 containing the subject location to produce the suitability weight vector 1704 for the subject hexagonal cell 1710. The suitability weight vector 1704 comprises a plurality of weight values, each weight value of the plurality being associated with a respective criterion of a plurality of criteria. In one embodiment, the plurality of criteria comprises a competitive intensity criterion, an accessibility criterion, a demographic criterion, a demand potential criterion, and an infrastructure proximity criterion.

In one embodiment, the predictive model 1700 further outputs, in response to the feature vector 1702, a plurality of feature contribution values 1712, each feature contribution value of the plurality indicating an influence of a respective input feature on the suitability weight vector 1704 for the subject hexagonal cell 1710. The plurality of feature contribution values 1712 is computed by the predictive model 1700 using a feature attribution procedure, such as a Shapley value computation, a gradient-based attribution computation, or a permutation-based attribution computation, applied to the trained predictive model 1700. The plurality of feature contribution values 1712 permits a user to understand which of the input features most influenced the suitability weight vector 1704 for the subject hexagonal cell 1710.

In one embodiment, the suitability weight vector 1704 is normalized such that a sum of the weight values of the suitability weight vector 1704 is equal to one. The normalization permits the suitability weight vector 1704 to be used directly as a weighting in the composite suitability score computation described below, without further adjustment.

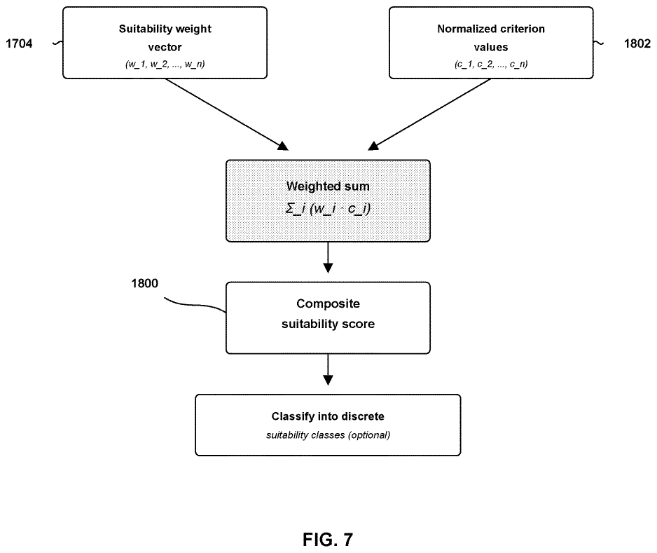

Referring now to FIG. 7, the processor 1102 computes a composite suitability score 1800 for the subject location as a weighted sum of a plurality of normalized criterion values 1802 associated with the subject hexagonal cell 1710, each weight of the weighted sum being derived from the suitability weight vector 1704 for the subject hexagonal cell 1710. The composite suitability score 1800 is computed as a sum, taken across every criterion of the plurality of criteria associated with the subject hexagonal cell 1710, of the product of (i) the weight value of the suitability weight vector 1704 associated with that criterion, and (ii) the normalized criterion value of the plurality of normalized criterion values 1802 associated with that criterion.

In one embodiment, each normalized criterion value of the plurality of normalized criterion values 1802 is derived from one of the feature value 1400 of the subject hexagonal cell 1710, the distance-weighted influence value 1500 of the subject hexagonal cell 1710, the spatial feature vector 1510 of the subject hexagonal cell 1710, or any combination thereof. The normalized criterion value falls within a defined numerical range, such as zero to one, regardless of the absolute magnitude of the underlying feature value or influence value.

In one embodiment, the processor 1102 further computes a respective composite suitability score for each hexagonal cell of a candidate subset of the plurality of hexagonal cells, and ranks the hexagonal cells of the candidate subset by the respective composite suitability scores. In another embodiment, the processor 1102 classifies each hexagonal cell of the candidate subset into one of a plurality of discrete suitability classes based on the respective composite suitability score. In one embodiment, the plurality of discrete suitability classes comprises a high suitability class, a moderate suitability class, and a low suitability class, with thresholds defined by quantiles of the composite suitability scores across the candidate subset.

The processor 1102 outputs the composite suitability score 1800 through the output interface 1112. In one embodiment, the output interface 1112 transmits the composite suitability score 1800 to the user device 1110 as a numerical value. In another embodiment, the output interface 1112 transmits a visualization representation of the geographic region in which each hexagonal cell of the candidate subset is rendered with a color or shading that indicates the respective composite suitability score for that hexagonal cell. In yet another embodiment, the output interface 1112 transmits the composite suitability score 1800, the plurality of feature contribution values 1712, the plurality of normalized criterion values 1802, the suitability weight vector 1704, or any combination thereof, to a downstream computational process for further analysis.

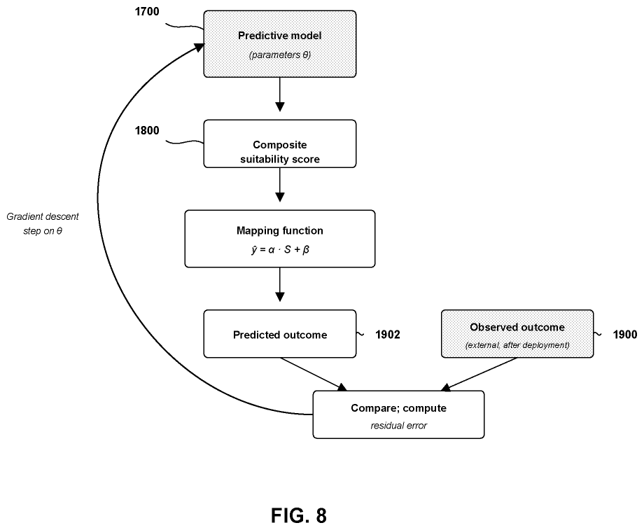

Referring now to FIG. 8, in one embodiment, the processor 1102 receives an observed outcome 1900 associated with the subject location after the composite suitability score 1800 has been output, compares the observed outcome 1900 with a predicted outcome 1902 derived from the composite suitability score 1800, and updates, based on the comparison, at least one parameter of the predictive model 1700.

The observed outcome 1900 comprises any measurable result that occurs at the subject location after the composite suitability score 1800 has been output. In one embodiment, the observed outcome 1900 comprises a measured transaction volume at the subject location over a defined time window, a measured customer count at the subject location, a measured revenue from operations at the subject location, a measured property value of the subject location, or any combination thereof. The observed outcome 1900 is received by the processor 1102 through the network interface 1106 from the user device 1110, from the geospatial data source 1108, or from any other source communicatively coupled to the processor 1102.

The predicted outcome 1902 is derived from the composite suitability score 1800 through a mapping function defined by the processor 1102. In one embodiment, the mapping function is a linear function in which the predicted outcome 1902 is computed as a slope parameter alpha multiplied by the composite suitability score 1800 plus an intercept parameter beta, where alpha and beta are mapping parameters fit to historical data. In another embodiment, the mapping function is a non-linear function, such as a sigmoid, a logarithmic, or a piecewise-linear function of the composite suitability score 1800.

The processor 1102 updates the at least one parameter of the predictive model 1700 by performing a gradient descent step on the loss function described above, using a residual error between the observed outcome 1900 and the predicted outcome 1902 as the loss signal. In one embodiment, the at least one parameter comprises a weight of a node of a decision tree of the predictive model 1700. In another embodiment, the at least one parameter comprises a weight of a connection of a neural network of the predictive model 1700. In yet another embodiment, the at least one parameter comprises a mapping parameter of the mapping function described above, such that the mapping from composite suitability score 1800 to predicted outcome 1902 is refined over time even if the predictive model 1700 itself is held fixed.

The adaptive recalibration procedure permits the predictive model 1700 to refine its parameters in response to outcomes that actually occur at evaluated sites, rather than relying solely on the target labels 1602 generated by the self-supervised procedure described above. Over time, the predictive model 1700 becomes increasingly accurate at predicting outcomes for hexagonal cells with feature vectors similar to those of previously-evaluated subject locations.

In one embodiment, the processor 1102 receives a plurality of operational configuration parameters associated with the subject location and computes a financial projection for the subject location as a function of (i) the plurality of operational configuration parameters and (ii) the composite suitability score 1800.

The plurality of operational configuration parameters comprises any parameter that defines an operational aspect of the subject location. In one embodiment, the plurality of operational configuration parameters comprises a service category designation, a physical floor area, a count of service positions, a daily operating-hour count, a staffing count, a unit pricing parameter, or any combination thereof.

The financial projection comprises one or more financial metrics computed for the subject location over a defined projection horizon. In one embodiment, the financial projection comprises a projected revenue, a projected operating expense, a projected net operating income, a projected valuation, or any combination thereof. In one such embodiment, the projected revenue is computed as a product of (i) a projected transaction volume derived from the composite suitability score 1800 and (ii) a unit pricing parameter of the plurality of operational configuration parameters. The projected operating expense is computed as a fixed component plus a variable component that scales with the projected transaction volume. The projected net operating income is computed as the projected revenue minus the projected operating expense. The projected valuation is computed as the projected net operating income divided by a capitalization rate parameter received by the processor 1102 from the user device 1110 or retrieved from the non-transitory memory 1104.

In one embodiment, the processor 1102 receives a modified operational configuration parameter from the user device 1110 and recomputes the financial projection using the modified operational configuration parameter, without retraining the predictive model 1700. The recomputed financial projection reflects the effect of the modified operational configuration parameter on the projected financial metrics, permitting a user to evaluate the financial impact of alternative operational configurations at the subject location interactively.

The system 1100 and the methods described herein may be implemented using any combination of general-purpose computing hardware, special-purpose computing hardware, virtualized computing hardware, or cloud-based computing services. In one embodiment, the processor 1102 comprises a server computing device located in a data center, the user device 1110 comprises a client computing device communicatively coupled to the server computing device through a wide-area network, and the geospatial data source 1108 comprises a third-party data service communicatively coupled to the server computing device through the wide-area network. In another embodiment, the processor 1102, the non-transitory memory 1104, the network interface 1106, and the output interface 1112 are integrated into a single computing device communicatively coupled to the user device 1110 and to the geospatial data source 1108 through one or more network interfaces.

The non-transitory memory 1104 comprises one or more non-transitory computer-readable media. In one embodiment, the non-transitory memory 1104 comprises a magnetic storage medium, a solid-state storage medium, an optical storage medium, a flash memory device, a random-access memory device, a read-only memory device, or any combination thereof. The instructions stored in the non-transitory memory 1104 comprise computer-executable instructions in any programming language, including but not limited to a compiled language, an interpreted language, a scripting language, a query language, or any combination thereof.

The output interface 1112 comprises any interface through which an output of the system 1100 is conveyed to a user device 1110, to a downstream computational process, or to a persistent storage medium. In one embodiment, the output interface 1112 comprises a graphical user interface rendered on a display of the user device 1110. In another embodiment, the output interface 1112 comprises an application programming interface through which the system 1100 transmits the composite suitability score 1800, the financial projection, the visualization representation of the geographic region, or any combination thereof, to a downstream computational process. In yet another embodiment, the output interface 1112 comprises a file system interface through which the system 1100 persists the composite suitability score 1800, the financial projection, the visualization representation of the geographic region, or any combination thereof, to a non-transitory storage medium.

The particular embodiments disclosed herein are illustrative only, as the embodiments may be modified and practiced in different but equivalent manners apparent to those skilled in the art having the benefit of the present disclosure. It is therefore evident that the particular embodiments disclosed herein may be altered or modified, and any such variations are considered to fall within the scope of the present application. Accordingly, the protection sought herein is as set forth in the description and the appended claims as well as any other variations and modifications falling within the scope thereof.

What is claimed is:

1. A computer-implemented method for site suitability evaluation, the method comprising:
receiving, by a processor, location data identifying a subject location within a geographic region;
subdividing, by the processor, the geographic region into a plurality of hexagonal cells of a hexagonal grid, each hexagonal cell of the plurality having a defined cell-center coordinate and being adjacent to six neighboring hexagonal cells of the hexagonal grid;
assigning, to each hexagonal cell of the plurality, a feature value derived from geospatial data localized to that hexagonal cell;
computing, for each hexagonal cell of the plurality, a distance-weighted influence value as a function of the feature values of the hexagonal cells located within a neighbor ring of that hexagonal cell, and a kernel function that decreases with neighbor-ring distance from the hexagonal cell;
generating, for each hexagonal cell of a training subset of the plurality, a target label by aggregating the feature values of the hexagonal cells located within the neighbor ring of that hexagonal cell, the target label being generated without manual labeling;
training a predictive model, using the feature values and the target labels of the training subset, to output, in response to a feature vector of a given hexagonal cell, a suitability weight vector for the given hexagonal cell;
applying the trained predictive model to a feature vector of a subject hexagonal cell containing the subject location to produce a suitability weight vector for the subject hexagonal cell;
computing a composite suitability score for the subject location as a weighted sum of a plurality of normalized criterion values associated with the subject hexagonal cell, each weight of the weighted sum being derived from the suitability weight vector for the subject hexagonal cell; and
outputting the composite suitability score.

2. The method of claim 1, wherein the hexagonal grid is a hierarchical hexagonal grid in which each hexagonal cell of the plurality has a parent hexagonal cell at a coarser resolution of the hexagonal grid and a plurality of child hexagonal cells at a finer resolution of the hexagonal grid.

3. The method of claim 1, wherein the kernel function is one of a Gaussian function, an exponential decay function, and an inverse-distance function of the neighbor-ring distance.

4. The method of claim 1, wherein the neighbor ring of a hexagonal cell of the plurality comprises every hexagonal cell of the hexagonal grid located within an integer ring distance of the hexagonal cell, the integer ring distance being greater than or equal to one.

5. The method of claim 1, wherein the predictive model comprises a gradient-boosted regression model trained on the feature values and the target labels of the training subset.

6. The method of claim 1, further comprising:
receiving an observed outcome associated with the subject location after outputting the composite suitability score;
comparing the observed outcome with a predicted outcome derived from the composite suitability score; and
updating, based on the comparing, at least one parameter of the predictive model.

7. The method of claim 1, further comprising:
receiving a plurality of operational configuration parameters associated with the subject location; and
computing a financial projection for the subject location as a function of the plurality of operational configuration parameters and the composite suitability score.

8. The method of claim 1, further comprising:
computing a respective composite suitability score for each hexagonal cell of a candidate subset of the plurality of hexagonal cells; and
classifying each hexagonal cell of the candidate subset into one of a plurality of discrete suitability classes based on the respective composite suitability score.

9. A system for site suitability evaluation, the system comprising:
a processor; and
a non-transitory memory storing instructions that, when executed by the processor, cause the processor to perform operations comprising:
receiving location data identifying a subject location within a geographic region;
subdividing the geographic region into a plurality of hexagonal cells of a hexagonal grid, each hexagonal cell of the plurality having a defined cell-center coordinate and being adjacent to six neighboring hexagonal cells of the hexagonal grid;
assigning, to each hexagonal cell of the plurality, a feature value derived from geospatial data localized to that hexagonal cell;
computing, for each hexagonal cell of the plurality, a distance-weighted influence value as a function of the feature values of the hexagonal cells located within a neighbor ring of that hexagonal cell, and a kernel function that decreases with neighbor-ring distance from the hexagonal cell;
generating, for each hexagonal cell of a training subset of the plurality, a target label by aggregating the feature values of the hexagonal cells located within the neighbor ring of that hexagonal cell, the target label being generated without manual labeling;
training a predictive model, using the feature values and the target labels of the training subset, to output, in response to a feature vector of a given hexagonal cell, a suitability weight vector for the given hexagonal cell;
applying the trained predictive model to a feature vector of a subject hexagonal cell containing the subject location to produce a suitability weight vector for the subject hexagonal cell;
computing a composite suitability score for the subject location as a weighted sum of a plurality of normalized criterion values associated with the subject hexagonal cell, each weight of the weighted sum being derived from the suitability weight vector for the subject hexagonal cell; and
outputting the composite suitability score.

10. The system of claim 9, wherein the hexagonal grid is a hierarchical hexagonal grid in which each hexagonal cell of the plurality has a parent hexagonal cell at a coarser resolution of the hexagonal grid and a plurality of child hexagonal cells at a finer resolution of the hexagonal grid.

11. The system of claim 9, wherein generating the target label comprises computing a mean of the feature values of the hexagonal cells located within the neighbor ring of that hexagonal cell.

12. The system of claim 9, wherein the suitability weight vector is normalized such that a sum of the weights of the weighted sum is equal to one.

13. The system of claim 9, wherein the operations further comprise:
receiving an observed outcome associated with the subject location after outputting the composite suitability score;
comparing the observed outcome with a predicted outcome derived from the composite suitability score; and
updating, based on the comparing, at least one parameter of the predictive model.

14. The system of claim 9, wherein the operations further comprise classifying the subject hexagonal cell into one of a plurality of discrete suitability classes based on the composite suitability score.

15. A non-transitory computer-readable medium storing instructions that, when executed by a processor, cause the processor to perform operations comprising:
receiving location data identifying a subject location within a geographic region;
subdividing the geographic region into a plurality of hexagonal cells of a hexagonal grid, each hexagonal cell of the plurality having a defined cell-center coordinate and being adjacent to six neighboring hexagonal cells of the hexagonal grid;
assigning, to each hexagonal cell of the plurality, a feature value derived from geospatial data localized to that hexagonal cell;
computing, for each hexagonal cell of the plurality, a distance-weighted influence value as a function of the feature values of the hexagonal cells located within a neighbor ring of that hexagonal cell, and a kernel function that decreases with neighbor-ring distance from the hexagonal cell;
generating, for each hexagonal cell of a training subset of the plurality, a target label by aggregating the feature values of the hexagonal cells located within the neighbor ring of that hexagonal cell, the target label being generated without receiving a manually-labeled training data set;
training a predictive model, using the feature values and the target labels of the training subset, to output, in response to a feature vector of a given hexagonal cell, a suitability weight vector for the given hexagonal cell;
applying the trained predictive model to a feature vector of a subject hexagonal cell containing the subject location to produce a suitability weight vector for the subject hexagonal cell;
computing a composite suitability score for the subject location as a weighted sum of a plurality of normalized criterion values associated with the subject hexagonal cell, each weight of the weighted sum being derived from the suitability weight vector for the subject hexagonal cell; and
outputting the composite suitability score.

16. The non-transitory computer-readable medium of claim 15, wherein the hexagonal grid is a hierarchical hexagonal grid in which each hexagonal cell of the plurality has a parent hexagonal cell at a coarser resolution of the hexagonal grid and a plurality of child hexagonal cells at a finer resolution of the hexagonal grid.

17. The non-transitory computer-readable medium of claim 15, wherein the predictive model further outputs, in response to the feature vector of the subject hexagonal cell, a plurality of feature contribution values, each feature contribution value indicating an influence of a respective input feature on the suitability weight vector for the subject hexagonal cell.

18. The non-transitory computer-readable medium of claim 15, wherein the operations further comprise:
receiving a plurality of operational configuration parameters associated with the subject location; and
computing a financial projection for the subject location as a function of the plurality of operational configuration parameters and the composite suitability score.

19. The non-transitory computer-readable medium of claim 15, wherein the operations further comprise generating a visualization representation of the geographic region in which each hexagonal cell of a candidate subset of the plurality of hexagonal cells is associated with a respective composite suitability score for that hexagonal cell.

20. The non-transitory computer-readable medium of claim 15, wherein the predictive model is trained without receiving a manually-labeled training data set for any hexagonal cell of the plurality.
